(19) United States
(12) Patent Application Publication
(10) Pub. No.: US 2026/0239297 A1
(43) Pub. Date: Aug. 13, 2026

(54) RANDOM ACCESS

(71) Applicant: Nokia Technologies Oy, Espoo (FI)

(72) Inventors: Zexian LI, Espoo (FI); Halit Murat GÜRSU, Munich (DE); Juha Sakari KORHONEN, Espoo (FI); Frank FREDERIKSEN, Aalborg (DK)

(21) Appl. No.: 19/155,684

(22) PCT Filed: May 31, 2023
(86) PCT No.: PCT/EP2023/064606

§ 371 Date: Aug. 12, 2025

(51) Int. Cl. H04W 72/02; H04W 48/16; H04W 72/543

(52) U.S. Cl. CPC H04W 72/02; H04W 48/16; H04W 72/543

(57) ABSTRACT

Methods, apparatus and systems for random access in a communication network are disclosed.

### FIELD

The following disclosure relates to the field of communication technology, in particular in a communication network, in particular a wireless communication network. The disclosure relates to the selection of access resources used by at least one of user equipments (UE) for random access to a network, for instance to a network node of a communication network.

### BACKGROUND

In modern communication technologies, random access (RA) procedure fulfils, for instance, the purpose to enable a user equipment (UE) to acquire an uplink (UL) synchronization. It may further serve the purpose to obtain resources for the following (e.g., user plane) UL or downlink (DL) communication. By performing a random access, the UE attempts to initiate access to the network. It is a one-sided action in which a signal (may be called message, preamble or signature) is sent to the network without real-time coordination with the network nodes or other UEs. As a result, it can happen that multiple UEs attempt to access the network in the same way (e.g., at the same time and/or using a similar/same radio resource and/or the same/similar signal, e.g. signal content). As a result, a collision happens, also called contention. For this case, so-called contention based random access (CBRA) approaches may be required.

### SUMMARY OF SOME EXEMPLARY EMBODIMENTS

In 5G new radio (NR), two types of random access procedures have been specified for a so-called contention based random access (CBRA) case: 4-step and 2-step random access procedure. The 4-step RACH procedure is the traditional “full handshake” procedure where both nodes of the system will obtain knowledge and confirmation that the messages have been received by the corresponding node in the system. Contention-free based random access (CFRA) is also supported, where a dedicated preamble sequence is allocated by the base station (e.g., a Next Generation NodeB (gNB)) and such preambles are known as dedicated random access preamble.

Considering the CBRA (contention based random access), if a physical random access channel (PRACH) becomes congested i.e. preamble collisions become too frequent, a few ways are imaginable to handle the situation: (1) An access barring may prevent a UE starting random access at all. In this case, the UE may be prevented from attempting another random access, for instance for a predefined amount of time. This delays access to the network. (2) A back-off indicator in random access response may be signaled (e.g., in a random access response message). Similarly to the first option, the network may control how long UEs on the average wait before trying again after a failed random access, e.g., a failed preamble transmission. (3) More PRACH resources may be configured. The access barring and back-off are directly affecting UEs by delaying or preventing the access. Configuring additional resources allows easing the congestion without affecting initial access latency but causes a lowered availability of resources for other communication. Also, updating the resource configuration for PRACH transmission may consume a considerable amount of time which may again delay random access of the UE. On top of this, due to the random, uncoordinated nature of contention based random access, there is no guarantee that in a subsequent RA attempt, the UE will be able to access the network, e.g., due to high collision probability.

It is thus one of the objects of this disclosure to support random access with a particularly high success probability. In some embodiments, in case the UE already started a random access procedure, the network (e.g., a network node of the network) may ensure (e.g., guarantee) that the UE is able to successfully complete the RA procedure assuming the channel condition is good enough.

According to a first exemplary aspect, a method is disclosed, comprising:
obtaining at least one association between at least one user equipment property and at least one random access resource from a network node,
selecting a random access resource from the at least one random access resource based on both at least one of the at least one association and a user equipment property (e.g., of an apparatus at least one of performing or controlling the method), and
at least one of transmitting initially or re-transmitting a random access message to a network node using the selected random access resource.

This method may for instance be performed and/or controlled by an apparatus, for instance a server. Alternatively, this method may be performed and/or controlled by more than one apparatus, for instance a server cloud comprising at least two servers. Alternatively, the method may for instance be performed and/or controlled by an electronic device, e.g. a node in a communication system and/or by a user equipment (UE). For instance, the method according to the first aspect may be performed and/or controlled by using at least one processor of the electronic device.

According to a further exemplary aspect, a computer program is disclosed, the computer program when executed by a processor causing an apparatus, for instance a server, a network node or a UE, to perform and/or control the actions/steps of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-(e.g., only) Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first exemplary aspect. The apparatus may in particular be a UE.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise (e.g., only) the disclosed components, for instance means, processor, memory, or may further comprise one or more additional components.

A user equipment (UE) may for instance here, in the foregoing and following correspond to a mobile device such as for example a mobile phone, a smartphone, a tablet, a smartwatch, a laptop, a Personal Digital Assistant (PDA) device, a wearable, an Internet-of-Things (IOT) device, an IIOT (Industrial IOT) device, a vehicle and/or combinations thereof. Such a user equipment may also be referred to as at least one of a user device or a mobile device.

A network node may here, in the foregoing and following correspond to a component of a communication network such as for instance a Base Transceiver Station (BTS), a nodeB, an evolved node B (eNB), a Next Generation NodeB (gNB), a distributed unit (DU), a central unit (CU) and/or combinations thereof.

The network node and/or the UE may be part of a communication network according to at least one network standard, such for instance as defined by the 3rd Generation Partnership Project (3GPP), www.3gpp.org, such as GSM or 2G, 3.5G, UMTS or 3G, LTE of 4G, 5G NR or 6G.

Obtaining at least one association from a network node may for instance comprise receiving a configuration, for instance by means of a communication link of a communication network. Obtaining at least one association may for instance comprise obtaining a physical random access channel (PRACH) configuration, wherein for instance the PRACH configuration may comprise the at least one association.

According to an embodiment of the first exemplary aspect, obtaining at least one association may comprise receiving the at least one association by means of at least one of a broadcast channel, a multicast channel, a UE-dedicated channel, a system information block (SIB, SIB2), a radio resource control (RRC) signaling, a downlink control information (DCI), an uplink control information (UCI) and/or combinations thereof.

A random access resource may for instance comprise a PRACH resource. A random access resource may for instance correspond to a radio resource defined in at least one of frequency or time, in particular in frequency and time. A random access resource may comprise a (e.g., random access) preamble and/or a (e.g., random access) preamble sequence. A random access resource may for instance correspond to a set of (e.g., random access) preamble sequences. A random access resource may correspond to a physical random access channel (PRACH).

A random access resource may be used by the UE to attempt a random access to a network, in particular to a network to which the network node belongs from which the at least one association has been obtained. At least one node of the communication network may be configured to (e.g., permanently or at pre-defined times) receive signals (e.g., random access messages) on the random access resource, in particular from UEs. A random access resource may be specific to a given cell within which a UE is positioned and/or may alternatively be defined for multiple cells and/or for all cells of the communication network.

The at least one association may comprise an association between at least one or more UE properties and at least one or more random access resources. An association associates at least one user equipment property to at least one random access resource. The at least one association may comprise at least 1, 2, 3, 4, 5, 8, 10, 16, 20, 32, 40, 50, 60, 64 or more individual associations. Such plurality of associations may be referred to as a set of associations and/or as a rule set. An association may for instance correspond to a rule that relates a given UE property to a given random access resource. An association may relate a value and/or a range of values of at least one or more UE property to at least one or more random access resources. An association may for instance correspond to and/or be represented by an if-else clause (e.g., if UE property X has a value between a and b, then use resource Y), a switch clause, a look-up table, for instance a single or multiple rows in a look-up table, a graph, in particular an edge of a graph in which nodes are one of UE property or random access resource, a (e.g., generative) function taking at least one UE property as an input and outputting at least one random access resource, a rule-based association such as for instance a fuzzy logic and/or combinations thereof.

For instance, at least one of the at least one association may relate a (e.g., single) value (e.g., value range) of values a given UE property may assume to a (e.g., single) random access resource. For instance, taking the UE property quality of service (QOS) requirement, the association may (e.g., only) relate a value range of one particular QoS requirement (e.g., delay) to a given random access resource. For instance, “if delay requirement <100 ms and >10 ms, then use random access resource X”. In this case, the output of the association may for instance be limited to either nothing, i.e., this particular association does not apply, or alternatively random access resource X. Additionally or alternatively, at least one of the at least one association may be able to output at least to different random access resources depending on the value of at least one UE property. An example may be “if delay requirement ≤10 ms, then use random access resource Y; elseif delay requirement <100 ms and >10 ms, then use random access resource X”.

Additionally or alternatively, at least one of the at least one association may base its output (i.e., random access resource) on at least two or more (e.g., mutually different) UE properties.

The at least one association may be organized by priorities. For instance, at least one association may have a higher priority than at least one other association. If these associations output mutually different random access resources to use, the one with a higher priority may take precedence over the other. In this way, associations may be ordered by priority. Additionally or alternatively, associations may be considered jointly for random access resource selection. For instance, multiple associations may output multiple random access resources to select. The random access resource which is output the most across all association outputs for may be selected (e.g., by a UE for subsequent random access message (re-) transmission).

At least one association may associate at least one user equipment property to at least one random access resource that may be selected and/or used (e.g., only) for initial transmission of a random access message. Additionally or alternatively, at least one association may associate at least one user equipment property to at least one random access resource that may be selected and/or used (e.g., only) for re-transmission of a random access message. Additionally or alternatively, at least one association may associate at least one user equipment property to at least one random access resource that may be selected and/or used for both initial transmission and re-transmission of a random access message.

Obtaining at least one association may for example comprise (e.g., initially) configuring a UE. The UE may for instance be programmed with a (e.g., invariable) set of associations. Obtaining may additionally or alternatively comprise an (e.g., dynamic) adjustment or at least one association, for instance based on receiving at least one indication of adjustment. Obtaining at least one association may for example comprise obtaining at least one association and replacing an existing, for instance stored, association. For instance, an obtained at least one association may replace any stored at least one association. Additionally or alternatively, at least one obtained association may partially replace at least one stored association. Additionally or alternatively at least one obtained association may be used to update at least one stored association.

Selecting a random access resource from the at least one random access resource based on both at least one of the at least one association and a user equipment property of an apparatus at least one of performing or controlling the method according to the first aspect may comprise determining a current UE property. For instance, a current value of a UE property may be determined. For instance, the current energy state may be determined by measuring the battery voltage or a recently used random access resource may be retrieved from a memory of the apparatus. As a UE may perform the method according to the first aspect, the UE may derive one of its own properties as the UE property on which the selection of a random access resource is based. By using a (e.g., current) UE property to select a random access resource, the UEs current state can be dynamically taken into account for random access (e.g., for selecting a random access resource).

The selecting of a random access resource comprises using the one of more of the obtained associations in combination with the UE property. For instance, if the association takes the shape of a function which takes a UE property as an input and outputs a random access resource, the method may involve calling said function with the UE property as an input. By basing the selection on an association provided by the network (e.g., by a network node of the network), the network can control which random access resource to allow and by which mechanism the available resources are to be selected. The network may for instance control how often certain resources may be used, under what circumstances certain resources are allowed to be accessed, what UE properties are relevant for random access resource selection, it may define backup resources for urgent cases that are only allowed for certain UEs and/or certain UE properties and/or combinations thereof.

The method according to the first aspect further comprises at least one of transmitting initially or re-transmitting a random access message to a network node using the selected random access resource. The network node to which the transmission and/or re-transmission is done, may for instance be identical to and/or different from the network node from which the association has been obtained. A random access message may for instance comprise and/or correspond to a random access preamble, a random access signature, a random access indication and/or combinations thereof. Initially transmitting a random access message may mean that this is the first transmission of this random access message, for instance, after having transmitted a different random access message and/or after an idle mode phase of an apparatus (e.g., a UE) performing and/or after powering on of an apparatus (e.g., a UE) and/or controlling the method according to the first aspect. A re-transmission of a random access message may correspond to a transmission of a random access message that has (e.g., immediately) before been transmitted in the same form (e.g., with the (essentially) same contents). Between the prior transmission of the random access message and the subsequent re-transmission of the random access message, no other random access message may have been transmitted. Typically, a re-transmission happens after a failed (e.g., first, second, or more) attempt to perform a random access, for instance using a particular random access resource.

A (re-)transmission may involve using at least one antenna of an apparatus performing and/or controlling the method according to the first exemplary aspect and/or transmitting at least one signal using a wireless beam.

A random access resource may be selected for an initial transmission, a re-transmission or both. A re-transmission of a random access message can be done using a random access resource used for a prior initial transmission and/or the prior re-transmission. It is also possible to use, for a re-transmission, a different random access resource compared to a (e.g., immediately) precedingly used random access resource.

The method according to the first exemplary aspect may further comprise obtaining (e.g.,, receiving) a random access response from the network node to which it (re-)transmitted a random access message. The random access response may for instance indicate whether collision resolution is required or not. A collision resolution may for instance be required if another UE (in addition to a UE performing and/or controlling the method according to the first exemplary aspect) used overlapping contents of random access messages, in particular the same PRACH preamble, at the at least partially same time.

Receiving no RAR (e.g., within a predefined time window following (re-) transmission) may indicate a failed random access attempt.

According to an embodiment of the first exemplary aspect,
at least one of the at least one user equipment property comprises at least one of an apparatus identification, a random access transmission time, a number of random access message transmissions, a quality of service requirement, or an energy state of an apparatus.

A user equipment property of at least one association is for instance a property of an apparatus performing the method according to the first aspect. For instance, a UE may perform at least parts or the (e.g., entire) method according to the first aspect. The at least one association relates a property of this apparatus to a random access resource. The UE property may be evaluable by the apparatus performing the method according to the first aspect.

For instance, a UE property may comprise an apparatus identification. Such an apparatus identification may for instance correspond to a user equipment ID, a phone number for which the apparatus is registered in the network, a serial number, an International Mobile Station Equipment Identity (IMEI) and/or combinations thereof. The apparatus identification may for instance be stored in hardware and/or software.

Additionally or alternatively, the UE property may also comprise a random access transmission time, for instance a random access message transmission and/or re-transmission time. For instance, the random access transmission time may correspond to a (e.g., first) PRACH transmission time. A random access transmission time may for instance be expressed as a slot (e.g., frame, subframe and/or subslot etc.) number, wherein for instance, the communication (e.g., using at least one certain channel) may be sectioned in time into (e.g., transmission) slots. An association may for instance apply a function, for instance a modulo operation, to the random access time, in order to derive an indication of a random access resource to select.

Additionally or alternatively, at least one association may cause the selection of, or allow the user equipment, a special random access resource (e.g. an overflow random access resource) to be used or to use (e.g. by the user equipment, e.g. the apparatus) if or when the user equipment may have failed to access the network at least a (e.g. predetermined) number of attempts respectively times. Additionally or alternatively, the UE property may comprise a number of random access message transmissions. For instance, the number of random access message transmissions may relate to the number of transmissions (and re-transmissions) of (e.g., mutually identical) random access messages. The number of random access message transmissions may correspond to the number of (e.g., failed) attempts to access the network via random access. For instance, an association may provide for a mechanism according to which at least one random access resource (e.g., PRACH) may be provided (e.g., reserved) for apparatuses that failed to access the network at least a predetermined number of times. For instance, such predetermined number of attempted (e.g., and failed) random accesses may be at least 1, 2, 3, 4, 5, 6, 7, 8, 9, 10, 11, 12, 13, 14, 15, 16, 17, 18, 19, 20, 30, 32, 50, 64, or more. At least one association may cause the selection of a certain (e.g., reserved for this purpose, e.g. overflow) random access resource depending on the predetermined number of retries, or attempts, as disclosed above. By providing such a random access resource, excessive numbers of re-tries may be prevented.

Additionally or alternatively, the UE property may comprise a quality of service (QOS) requirement, for instance of (e.g., an application being executed by) the apparatus performing and/or controlling the method according to the first aspect. Such a QoS requirement may for instance correspond to a maximum acceptable latency requirement, a data rate requirement, a priority requirement and/or combinations thereof.

Additionally or alternatively, the UE property may comprise an energy state of an apparatus, for instance the apparatus performing and/or controlling the method according to the first aspect. For instance, an association may cause selection of a (e.g., allow access to) random access resource with lower congestion probability compared to at least one or (e.g., all of) the at least one random access resources that are selectable according to at least one of the at least one association. Such a random access resource may for instance comprise a larger frequency range, a longer time span and/or may be accessed (e.g., by UEs) with a small probability compared to other random access resources, for instance because of according associations provided to at least one or more UEs.

According to an embodiment of the first exemplary aspect,
at least one of the at least one user equipment property comprises a random access resource used for a preceding transmission of the random access message.

The UE property may comprise a random access resource used for an (e.g., immediately) preceding transmission of the random access message. The transmission may be an initial transmission but may also be re-transmission of the random access message (here, in the foregoing and following abbreviated as “(re-)transmission”). The preceding (re-)transmission may in particular have been done by using the (e.g., same and/or identical and/or essentially identical) random access message used for the (re-)transmission according to the method according to the first exemplary aspect. In other words, the UE property may relate to the random access resource used for the latest previous random access message (re-)transmission. Such latest random access message (re-)transmission may in particular correspond to a failed random access attempt. The at least one UE property may thus additionally or alternatively correspond to a random access resource used for the latest failed random access attempts, in particular the latest initial transmission of a random access message leading to a failed random access attempt.

According to an embodiment of the first exemplary aspect, the method further comprises
obtaining at least one barring indication of at least one barred random access resource from a network node.

The at least one barring indication may indicate at least one barred random access resource. It may also indicate a plurality of barred random access resources. In other words, a barring indication may indicate at least one random access resource is barred for use (e.g., for (re-)transmitting a random access message), e.g. by the apparatus obtaining the barring indication. For instance, the barring indication may comprise a temporal limitation. For instance, the barring indication may indicate that one or more random access resources are barred for a pre-defined timespan, e.g., starting immediately or starting at a later or earlier, predefined time and/or lasting for a pre-defined amount of time. For instance, a barring indication may indicate that a random access resource is barred for an amount of time of at least 100 ms, 200 ms, 500 ms, 1 s, 2 s, 5 s, 10 s, 30 s, 1 min, 2 min, 5 min, 10 min, 20 min, 30 min, 1 h, 2 h, 3 h, 4 h or longer. Additionally or alternatively, a barring indication may indicate that a random access resource is barred without a temporal limitation. For instance, the barring may in this case remain active until an un-barring indication is obtained indicating that a (e.g., barred) random access resource is not barred (e.g., any longer).

A barring indication may be specific to at least one or more apparatuses (e.g., UEs). For instance, the barring may be dependent on at least one UE property. Such properties may be at least one of the ones disclosed above with respect to the associations.

A barring indication may indicate a selective barring of a random access resource. An apparatus obtaining such a selective barring indication may be allowed to (re-)transmit random access messages to at least one random access resource while being barred from at least one other random access resource. In particular, a barring indication may not cause the apparatus obtaining it to be (e.g., entirely) barred from attempting any random access and/or in an entire cell, but only from attempting a random access using at least one barred random access resource while other random access resources remain accessible.

The barring indication may be received from a network node, for instance a network node to which a random access message is (re-)transmitted and/or from a different network node. The barring indication may be received by means of at least one of a broadcast channel, a multicast channel, a UE-dedicated channel, a system information block (SIB, SIB2), a radio resource control (RRC) signaling, a downlink control information (DCI), an uplink control information (UCI) and/or combinations thereof.

According to an embodiment of the first exemplary aspect,
selecting the random access resource comprises avoiding at least one or all barred random access resources indicated by the at least one barring indication for transmitting a random access message.

The at least one obtained barring indication may be taken into account when selecting a random access resource, in particular in addition to the at least one association. Selecting a random access resource may comprise avoiding at least one or all barred random access resource indicated by the at least one barring indication, in particular for an initial transmission of a random access message. For instance, a barred random access resource indicated by a barring indication may be avoided for initial transmission of a random access message while the barred random access resource is not avoided (i.e., may be considered allowed and/or non-barred) for re-transmission of the random access message. In other words, a barring may be (e.g., considered by an apparatus performing the method according to the first exemplary aspect) limited to initial transmission of the random access message and may not apply to the re-transmission of the random access message. In another example, the barring indication does not differentiate between initial transmission and re-transmission and applies to both equally.

According to an embodiment of the first exemplary aspect,
at least one of the at least one association causes (e.g., an apparatus at least one of performing or controlling the method of the first exemplary aspect) to select a random access resource used for a preceding transmission for a subsequent re-transmission of the random access message or
at least one of the at least one association causes the apparatus to select a random access resource used for a preceding transmission for a subsequent re-transmission of the random access message, when a barring indication indicating the radio access resource has been obtained by the apparatus after the preceding transmission of the random access message using the random access resource.

At least one association may cause the apparatus to select a random access resource which has been used (e.g., by the apparatus) for an (e.g., immediately) preceding transmission of the random access message. The selection of the random access resource is done for a subsequent re-transmission (e.g., of the same random access message). The preceding transmission may have been an initial transmission or a re-transmission. The preceding transmission may have failed. In other words the preceding transmission may have led to a failed random access attempt. The UE property specified by the respective association may be the (e.g., previously) used random access resource.

At least one of the at least one association may thus cause the apparatus to select the same random access resource for a subsequent transmission of a random access message which it used (e.g., and selected) for an (e.g., immediately) preceding transmission wherein for instance the preceding transmission of the random access message has led to a failed random access attempt. In other words, an apparatus performing and/or controlling the method may be forced to use the same random access resource again after a failed (e.g., initial) random access attempt.

According to an example, the at least one association may cause an apparatus performing the method to select the same random access resource as before (e.g., only and/or also) when a barring indication for the (e.g., same) random access resource has been received. Such a barring indication may have been received after the preceding transmission. The barring indication may indicate a barring of a random access resource for initial access (e.g., only). The barring indication may have been received before the subsequent transmission of a random access message using the (e.g., same) resource.

According to a second exemplary aspect, a method is disclosed, comprising:
constructing at least one association between at least one user equipment property and at least one random access resource, and
providing the at least one association to a user equipment.

This method may for instance be performed and/or controlled by an apparatus, for instance a server. Alternatively, this method may be performed and/or controlled by more than one apparatus, for instance a server cloud comprising at least two servers. Alternatively, the method may for instance be performed and/or controlled by an electronic device, e.g. a node in a communication system and/or by a user equipment (UE). For instance, the method according to the first aspect may be performed and/or controlled by using at least one processor of the electronic device.

According to a further exemplary aspect, a computer program is disclosed, the computer program when executed by a processor causing an apparatus, for instance a server, a network node or a UE, to perform and/or control the actions/steps of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-(e.g., only) Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first exemplary aspect. The apparatus may in particular be a network node.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise (e.g., only) the disclosed components, for instance means, processor, memory, or may further comprise one or more additional components.

Constructing at least one association may comprise selecting UE properties to base a selection of a random access resource on. Constructing an association may further comprise selecting at least one (e.g., available) random access resource which a UE may use for (re-) transmitting a random access message.

Constructing may further comprise devising at least one association (and/or rule) by which a UE may decide what random access resource to select and/or use. Constructing may involve updating an existing (e.g., set of) at least one association. The implementation of associations and further details disclosed with respect to the first aspect are herewith disclosed for the second exemplary aspect.

Providing the at least one association to a user equipment may for instance involve transmitting the at least one association to the UE. For instance, a PRACH configuration may be transmitted which may be indicative of and/or contain the at least one association. Providing may be done by means of at least one of a broadcast channel, a multicast channel, a UE-dedicated channel, a system information block (SIB, SIB2), a radio resource control (RRC) signaling, a downlink control information (DCI), an uplink control information (UCI) and/or combinations thereof.

Providing may for instance comprise indicating which (e.g., previously transmitted) associations are to be taken into consideration by the UE when selecting a random access resource. For instance, providing may involve transmitting an index to one, a subset of or all of a total set of associations to choose from. The associations to choose from may have been transmitted to the UE previously (e.g., from a network node) or may be stored in (e.g., programmed into) the UE, for instance during an initial configuration of the UE.

According to an embodiment of the second exemplary aspect, the method further comprises
receiving at least one of an initial transmission or a re-transmission of a random access message from a user equipment using one of the at least one random access resource.

Receiving a random access message may for instance comprise using an antenna, for instance an antenna controlled by and/or part of an apparatus controlling and/or performing the method according to the second exemplary aspect. Receiving may be done by means of at least one of a broadcast channel, a multicast channel, a UE-dedicated channel, a system information block (SIB, SIB2), a radio resource control (RRC) signaling, a downlink control information (DCI), an uplink control information (UCI) and/or combinations thereof.

The user equipment from which the (re-)transmission is received may be identical to the user equipment to which the at least one association has been transmitted. The UE from which the (re-)transmission is received may be an apparatus according to the first exemplary aspect. The at least one random access resource used by the received (re-)transmission (i.e., by a UE to (re-)transmit a random access message to the network node performing the method of the second exemplary aspect) may correspond to at least one random access resources of the at least one association provided to a UE, for instance to the UE from which the (re-)transmission is received.

The method according to the second exemplary aspect may further comprise providing (e.g.,, transmitting) a random access response (RAR) to a UE from which it received a (re-transmission) of the random access message. The random access response may for instance indicate whether collision resolution is required or not. A collision resolution may for instance be required if two or more UEs used similar (e.g., identical) random access resources and/or overlapping contents of random access messages, in particular the same PRACH preamble, at the at least partially same time. The method according to the second exemplary aspect may alternatively comprise sending no RAR if a (e.g., severe) collision/ interference occurred that may for instance render an identification of a sender of a random access message impossible.

According to an embodiment of the second exemplary aspect, further comprising at least one of
constructing the at least one association comprise selecting one or a subset of or all random access resources from a set of configured random access resources or
constructing the at least one association comprises configuring one or a subset or all of a set of available random access resources.

Constructing the at least one association may for instance comprise selecting one random access resource, a subset of random access resources or all random access resources from a set of configured random access resources. For instance, the method according to the second exemplary aspect may comprise configuring (e.g., pre-configuring) a set of configured random access resources. Constructing the at least one association may then comprise selecting (and/or, e.g., activating) the at least one random access resource from the set of configured random access resources. In this approach, no configuration of new resources is required in case it may be desired to make an additional random access resource available to a UE. Instead, at least one random access resource may be selected from the already configured random access resources.

Additionally or alternatively, constructing the at least one association comprises configuring one random access resource or a subset of random access resources or all random access resources of a set of available (e.g., configurable) random access resources. In this case, no activation phase is needed and no pre-configuration is required. New random access resources may be made available dynamically without reserving them before they are required.

Additional random access resources (i.e., at least one or more additional resources) can be activated (e.g., from a set of already configured ones) or configured. For instance, such additional random access resources may be made available if a high (e.g., increased) random access activity (e.g., load) on the already active and/or already configured random access resources is detected. This may for instance be the case when an excessive number of failed random access attempts is observed. The constructing may then comprise adding these newly activated and/or newly configured random access resources. Adding may for instance mean adding an association between a UE property and the added resource and/or updating the at least one association in order to provide the UE obtaining the at least one association with the option of selecting the newly configured/activated resource and/or indicating to a UE that at least one association involving the newly configured/activated resource is to be considered when selecting a random access resource.

According to an embodiment of the second exemplary aspect, the method may further comprise
providing at least one adapted association between at least one user equipment state and at least one random access resource to a user equipment.

The method according to the second exemplary aspect may comprise adapting at least one of the at least one association. For instance, at least one association may be added and/or removed. A priority and/or precedence of at least one association with respect to at least one other association may be altered (i.e., increased or decreased). Additionally or alternatively, at least one random access resource may be added (e.g., made available for selection by at least one UE), activated, configured, and/or removed (e.g., made unavailable for selection by at least one UE).

At least one adapted association may be provided to a user equipment, for instance by at least one of the means as disclosed above with respect to the provision of the at least one association.

For instance, at least one or the previously provided association may be replaced by an adapted association, an additional association may be provided that is added on top for the already provided associations, an association may be inactivated and/or deleted without replacement. The provision of at least one adapted association may comprise a transmission of at least one (e.g., adapted and/or new) association to the UE. The provision may for instance additionally or alternatively comprise providing an indication of an adaption of at least one association. For instance, the method according to the second exemplary aspect may comprise providing an index of an association to activate or de-activate. Providing at least one association may in an example comprise a replacement of an (e.g., the (e.g., entire)) set of associations previously provided to the UE and/or may comprise a partial replacement and/or a partial inactivation and/or an (e.g., incremental) addition of at least one association. Providing at least one association may in an example comprise adapting and/or assigning and/or removing a priority to at least one association.

According to an embodiment of the second exemplary aspect,
at least one of the at least one user equipment property comprises at least one of an apparatus identification, a random access transmission time, a number of random access message transmissions, a quality of service requirement, or an energy state of an apparatus.

Details are disclosed with respect to the first exemplary embodiment and are herewith disclosed for the second exemplary aspect as well.

According to an embodiment of the second exemplary aspect,
at least one of the at least one user equipment property comprises a random access resource used for a preceding transmission of the random access message.

Details are disclosed with respect to the first exemplary embodiment and are herewith disclosed for the second exemplary aspect as well.

According to an embodiment of the second exemplary aspect, the method further comprises
estimating an access latency for at least one random access resource, or
estimating an access latency for at least one random access resource and constructing at least one association based on the estimated access latency.

The access latency may for instance be indicative of how much time passes (e.g., maximally, on average, median across UEs, for instance during a given time span, and/or combinations thereof) between a first transmission of a random access message and a successful random access (e.g., using the same random access message and/or by the same UE). The access latency for at least one random access resource may for instance be estimated based on an average number of transmissions (initial transmissions and/or re-transmissions) of random access messages required for a successful random access.

Constructing at least one association may be at least partially based on the (e.g., estimated) access latency. For instance, an association between a required QoS of a UE and a random access resource may involve selecting a resource of low random access latency in case the required QoS involves a low latency.

According to an embodiment of the second exemplary aspect, the method further comprises
determining that at least one of the at least one random access resource is congested and
selectively barring the congested random access resource for initial transmissions of random access messages by user equipments.

If a random access resource is congested, this may for instance mean that more than a pre-defined share of (e.g., initial and/or re-) transmissions of random access messages do not lead to successful random accesses and/or require collision resolution. Typically, such a situation may arise when an excessive number of UEs attempts to access the network (e.g., network node) using the same random access resource. The pre-defined share may for instance be at least 20%, 30%, 40%, 50%, 60%, 70%, 80%, 90%, 95%, 99% or more.

Selectively barring certain random access resource may comprise barring at least one or more random access resources for subsequent (re-)transmissions of random access messages while leaving at least one or more other random access resources (e.g., of the same cell) available. Barring may include indicating to at least one UE that at least one random access resource is unavailable. In particular, barring may only apply to initial transmissions of random access messages. In other words, no new UEs which have not (e.g., immediately) previously attempted to transmit a random access message are allowed to initially transmit a random access message using the barred resource. But those who have already initially transmitted and are attempting to re-transmit the (e.g., same) random access message, may still be allowed to use the resource. By barring only a congested resource selectively and keeping others available, the currently congested resource will be freed from UEs attempting to access it. If only initial transmissions are blocked, the UEs currently attempting to access the network using the barred resource will one after the other be able to access the network through the less and less congested resource.

According to an embodiment of the second exemplary aspect, the method further comprises
selectively barring comprise transmitting at least one barring indication of at least one barred random access resource to at least one user equipment.

Barring may comprise transmitting at least one barring indication to at least one or more user equipments. At least one of the means disclosed for providing at least one association to the UE may be used to this end (e.g., broadcast) as well. The barring indication may have the properties as disclosed with respect to the first exemplary aspect.

According to a third aspect, a system is disclosed comprising at least one apparatus (e.g., a UE) performing and/or controlling the method according to the first exemplary aspect and at least one apparatus (e.g., a network node) performing and/or controlling the method according to the second exemplary aspect.

All features disclosed for any of the exemplary aspects are disclosed for the respective other exemplary aspects.

### BRIEF DESCRIPTION OF THE DRAWINGS

### In the Figures Show:

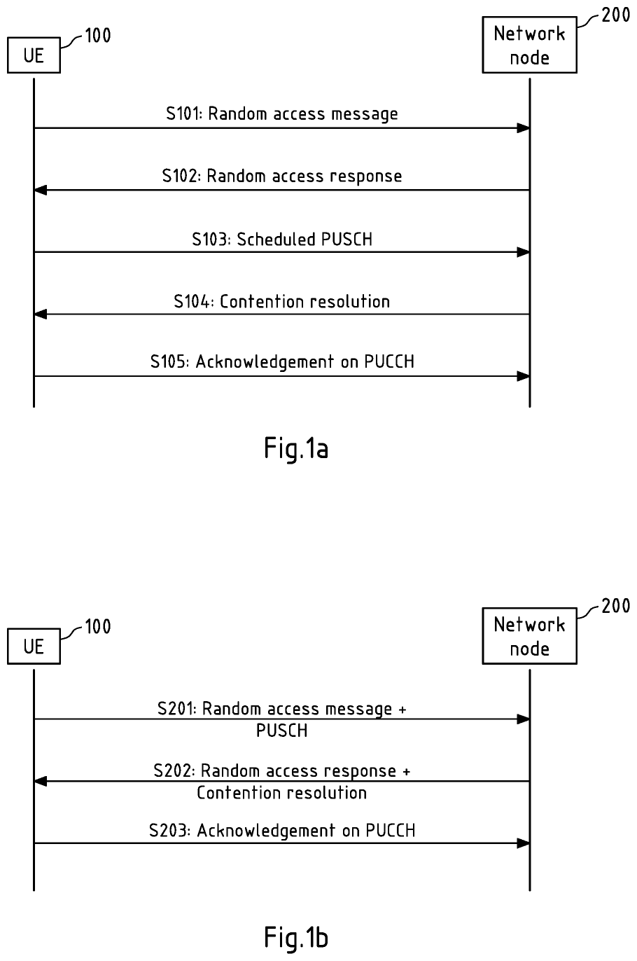

FIG. 1 a, b respective signaling diagrams showing exemplary embodiments according to the first, second and third exemplary aspect;

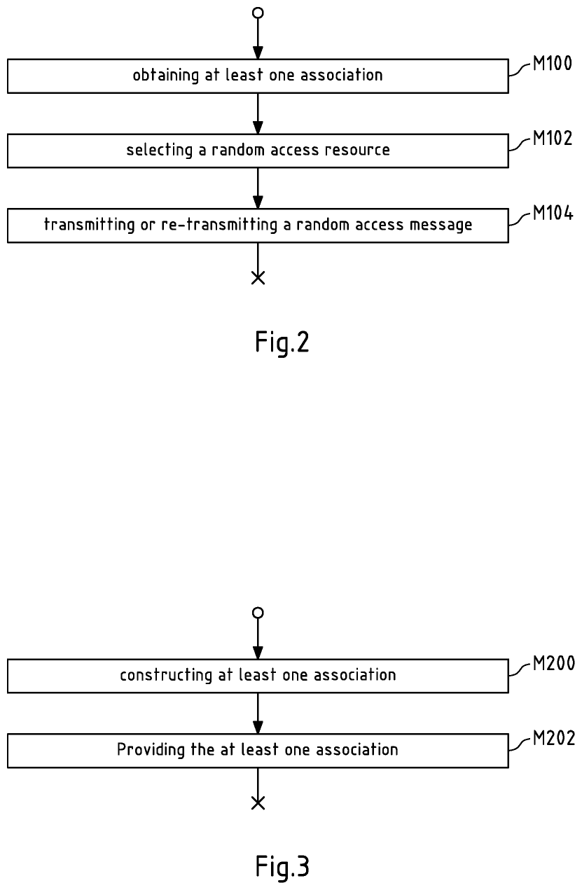

FIG. 2 a flow chart of a method according to an embodiment according to the first exemplary aspect;

FIG. 3 a flow chart of a method according to an embodiment according to the second exemplary aspect;

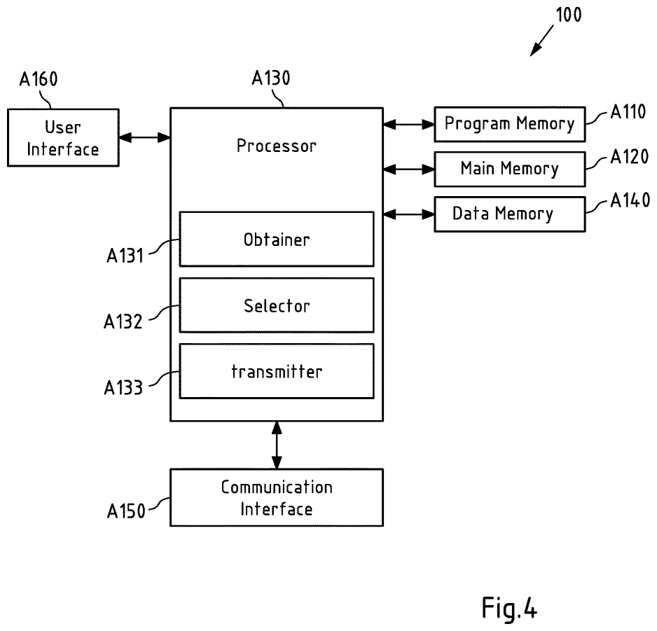

FIG. 4 a block diagram illustrating an embodiment according to the first exemplary aspect;

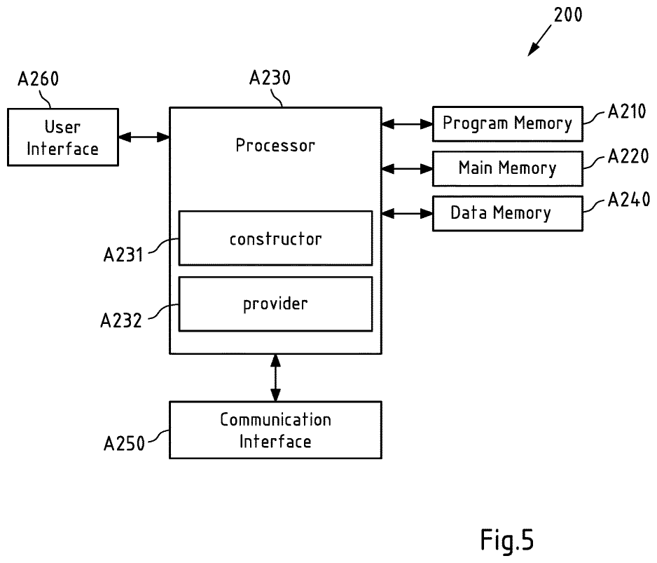

FIG. 5 a block diagram illustrating an embodiment according to the second exemplary aspect;

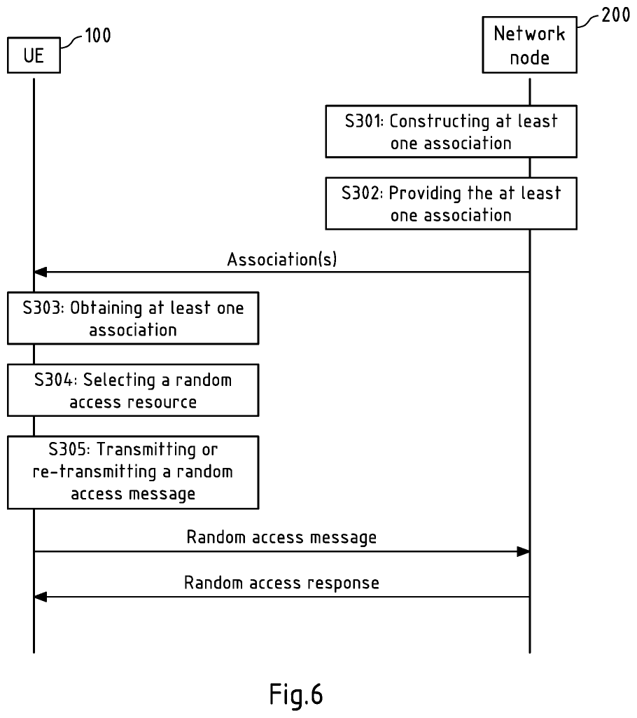

FIG. 6 a signaling diagram showing an exemplary embodiment according to the first, second and third exemplary aspect;

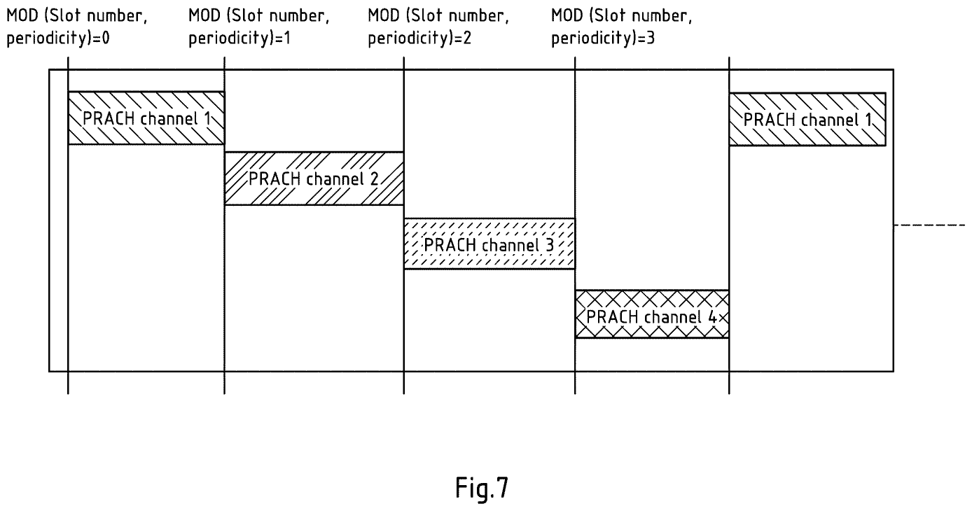

FIG. 7 an exemplary embodiment of an association according to the first, second and third exemplary aspect;

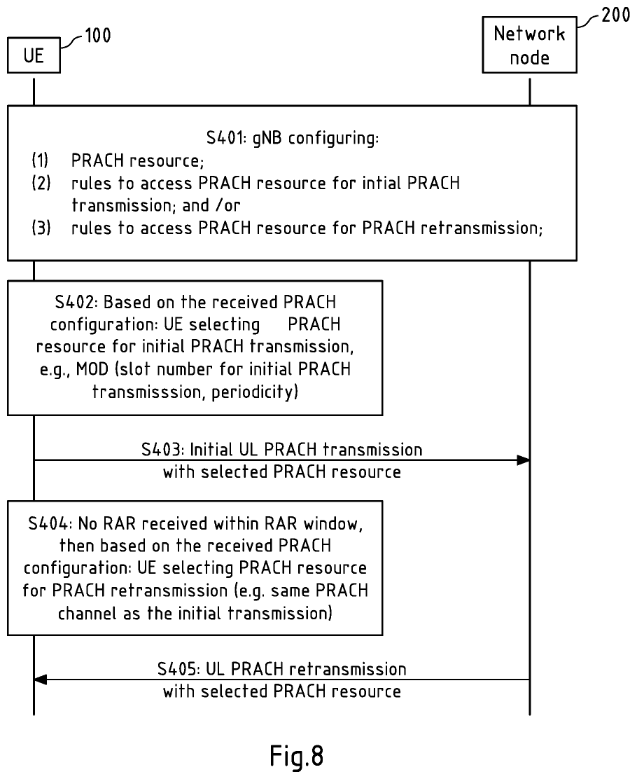

FIG. 8 a signaling diagram showing an exemplary embodiment according to the first, second and third exemplary aspect;

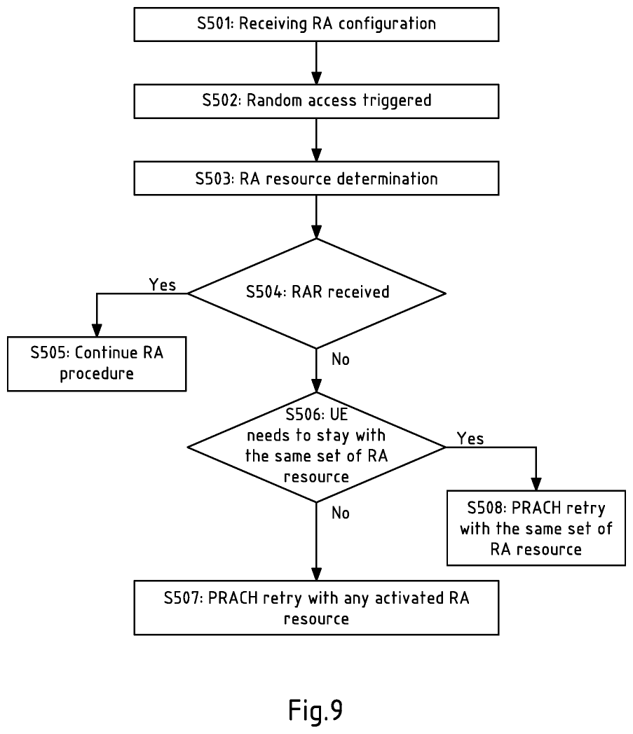

FIG. 9 a flow chart of a method according to an embodiment according to the first, second and third exemplary aspect;

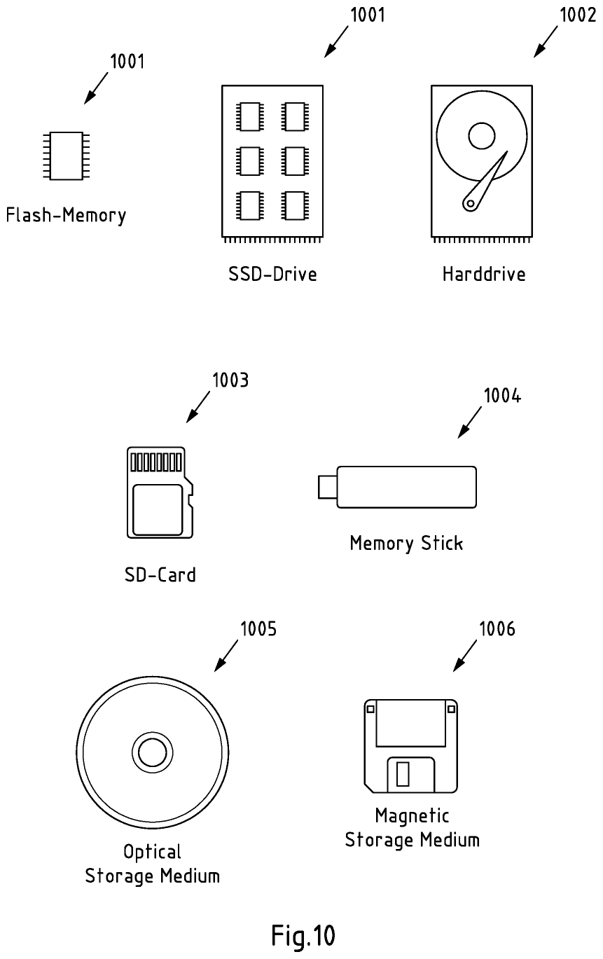

FIG. 10 examples of storage media.

FIG. 1a shows a 4-step random access procedure. A user equipment (UE) 100 transmits a random access message in step S101 to a network node 200, for instance a gNB. The random access message may for instance correspond to or comprise a preamble, for instance a PRACH preamble. In step S102, the network node 200 responds with a random access response (RAR) which it transmits to the UE 100. Consequently, the UE 100 transmits, in step S103, another message to the network node 200, for instance on a Physical Upload Shared Channel (PUSCH) and/or for instance an RRC connection request. In step S104, the network node responds again, for instance with a message for contention resolution and/or an RRC connection reply. The UE 100 may then respond with an acknowledgement on a Physical Uplink Control Channel (PUCCH) in step S105.

Prior to the shown signals, at least one random access resource may have been indicated to the UE 100, e.g., by the network node 200, for instance by a broadcast channel such as a system information block (SIB/SIB2). For step S101, the UE 100 may have selected a random access resource such as the PRACH, for instance based on at least one association between a UE property and at least one random access resource.

FIG. 1b shows a 2-step random access procedure in which steps S101 and S103 of the 4-step procedure of FIG. 1a are converted into a single step S201 and step S102 and S104 are converted into a single step S202. Step S203 corresponds to step S105 in FIG. 1a.

FIG. 2 illustrates an embodiment according to the first exemplary aspect as a flow chart. The shown steps may for instance be performed and/or controlled by a UE 100. In step M100, at least one association between at least one UE property and at least one random access resource is obtained, for instance received, for instance from a network node 200. In step M102, a random access resource is selected, at least partially based on the at least one obtained association. Using the selected random access resource, the UE may then transmit or re-transmit a random access message to a network node in step M104. The random access message may for instance comprise and/or correspond to a PRACH preamble.

FIG. 3 illustrates an embodiment according to the second exemplary aspect as a flow chart. The shown steps may for instance be performed and/or controlled by a network node 200. In step M200, at least one association between at least one UE property and at least one random access resource is constructed. The constructed at least one association is then transmitted to a UE 100 in step M202, for instance to at least one UE, for instance by a broadcast channel (e.g., SIB, SIB2).

FIG. 4 shows an exemplary block diagram of a UE 100, for instance performing and/or controlling the method according to the first exemplary aspect. The UE 100 may comprise a user interface A160, a program memory A110, a main memory A120, and a data memory A140. Further, it may comprise a processor A130. The UE 100 may further comprise functional units A131 to A133 which respectively correspond to the steps as shown in the flowchart of FIG. 2. The obtainer A131 is a functional unit allowing the UE 100 to obtain at least one association, for instance in conjunction with the communication interface A150. The selector A132 is a functional unit to select a random access resource based on the at least one obtained association. The UE 100 further comprises a transmitter A133 as a functional unit that allows the apparatus 100 to transmit a random access message another network entity, e.g., to a network node 200, e.g. using a selected random access resource. The transmitter A133 may for instance work together with the communication interface A150.

FIG. 5 shows an exemplary block diagram of a network node 200, for instance performing and/or controlling the method according to the second exemplary aspect. The network node 200 may comprise a user interface A260, a program memory A210, a main memory A220, and a data memory A240. Further, it may comprise a processor A230. The network node 200 may further comprise functional units A231 and A232 which respectively correspond to the steps as shown in the flowchart of FIG. 3. The network node 200 comprises a constructor A231 for constructing at least one association between a UE property and a random access resource. It further comprises a provider A232 for providing the at least one association to at least one UE 100. The provider A232 may for instance work together with the communication interface A250.

FIG. 6 illustrates in an example the joint actions of a UE 100 and a network node 200 according to the first and second aspect respectively and/or according to a system according to the third exemplary aspect. The UE 100 and network node 200 may be part of a system according to the third exemplary aspect. In steps S301 and S302, the network node 200 constructs and provides the at least one association between a UE property and a random access resource. The provision of the at least one association to the UE 100 is demonstrated by the arrow to the left. The UE 100 may then obtain the association (step S303), select a random access resource in step S304 and initially transmit and/or re-transmit a random access message to a network node, for instance the network node 200 from which it obtained the at least one association. After obtaining the association in step S303, the UE 100 may perform and/or control steps S304 and/or S305 without obtaining a (e.g., new) association. It may select the random access resource based on at least one of its (e.g., current) UE properties and attempt a random access in step S305 based on previously received associations. The network node 200 may respond to a (re-)transmitted random access message by transmitting a random access response to the UE 100.

FIG. 7 demonstrates an exemplary implementation of an association between a UE property and a random access resource. The UE property is an access time given as a slot number. A transmission may be possible in certain time slots that may be numbered, e.g. in temporally ascending order with step size 1.

The proposed rule underlying the association is a modulo operation that links the slot index (slot number) to a random access resource which in this case is a PRACH channel. A PRACH channel may be identified by an index. The modulo operation may take the slot number as a first input to apply the modulo operation to. Additionally, a periodicity N that may equate to the (e.g., total) number of random access resources available (here, N=4) may be a second input to the modulo operation. The modulo operation then outputs an index for the random access resource that takes one of the values 0, 1, . . . , N (here, 0, 1, 2, 3). This index may be used by the UE 100 to select the random access resource to then use in the (re-)transmission of the random access message.

FIG. 8 illustrated another embodiment of a UE 100, e.g. performing and/or controlling the method according to the first exemplary aspect, a network node 200, e.g., performing and/or controlling the method according to the second exemplary aspect, and/or to a system corresponding to the third exemplary aspect. In step S401 the network node, which may in this embodiment be a gNB, configures at least one random access resource, here a PRACH resource, for instance at least one PRACH. The network node 200 may then configure at least one association, for instance as a rule, between a UE property and a random access resource, for instance the one configured before. The associations may for instance be specific to initial random access message transmissions (e.g., PRACH transmission) or to random access message re-transmissions. At least one association may additionally or alternatively point to at least one random access resource that may be used for both initial transmission and re-transmission. In step S402, the UE 100 may select a random access resource (PRACH) based on the associations and/or the configuration received from the gNB 200. The association may for instance comprise the modulo rule as detailed with respect to FIG. 7. In step S403, an initial random access message is transmitted, for instance a PRACH preamble, for instance using the selected PRACH resource selected in step S402. The network node 200 may be configured to transmit a random access response (RAR) and/or the UE 100 may be configured to receive a random access response within a pre-defined time window. If no RAR is received, the UE 100 may determine that the random access attempt failed and may re-transmit the random access message. For instance, the UE 100 may select a (e.g., another or the same as for initial transmission) random access resource for re-transmission. The another random access resource selected for re-transmission may differ from the random access resource selected for initial transmission. For example, different associations are used for the selecting the random access resource for initial transmission and for re-transmission. In step S405, the UE 100 then re-transmits the random access message to the network node 200.

FIG. 9 illustrates as a flow chart a certain association that causes a UE 100 to continue using an initially selected random access resource. In step S501, the UE receives at least one association as a random access configuration (RA configuration). A random access may be triggered in step S502 and in step S503, the random access resource is selected (in other words, determined), in particular using the association (in other words, RA configuration) obtained previously. The UE 100 then initially transmits a random access message, e.g., PRACH preamble (step not shown). The UE 100 may also re-transmit a random access message based using the selected resource. The method then branches depending on the reception of a random access response in step S504. Receiving a random access response means that the random access attempt was successful. The UE 100 may then continue with the random access procedure in step S505. If the RAR is not received, i.e., the random access attempt failed, an association may force the UE 100 in step S506 to re-transmit the random access message (i.e., retry the random access) using the same resource as used before for initial transmission in step S508. The association may in this case relate the previously used random access resource (e.g., for initial transmission and/or for re-transmission) as a UE property to the subsequently used random access resource. Such an association may also be absent and/or inactivated and/or overridden by another association which explicitly allows using a different random access resource. In this case, the UE 100 may go on to step S507 and use another RA resource for re-transmission.

FIG. 10 is a schematic illustration of examples of tangible and non-transitory computer-readable storage media according to the present invention that may for instance be used to implement program and/or main memory A110, A120, A140, A210, A220, A240 of the apparatus 100 and/or 200 of FIGS. 4 and 5. FIG. 10 shows a flash memory 1000, which may for instance be soldered or bonded to a printed circuit board, a solid-state drive 1001 comprising a plurality of memory chips (e.g. Flash memory chips), a magnetic hard drive 1002, a Secure Digital (SD) card 1003, a Universal Serial Bus (USB) memory stick 1004, an optical storage medium 1005 (such as for instance a CD-ROM or DVD) and a magnetic storage medium 1006.

Furthermore, at least the following embodiments shall be considered to be specifically disclosed:

### Embodiment 1

A first apparatus comprising at least one processor; and at least one memory including instructions that, when executed by the at least one processor, cause the apparatus at least to perform and/or control
obtaining at least one association between at least one user equipment property and at least one random access resource from a network node,
selecting a random access resource from the at least one random access resource based on both at least one of the at least one association and a user equipment property of the first apparatus, and
means for at least one of transmitting initially or re-transmitting a random access message to a network node using the selected random access resource.

### Embodiment 2

The first apparatus according to embodiment 1, wherein
at least one of the at least one user equipment property comprises at least one of an apparatus identification, a random access transmission time, a number of random access message transmissions, a quality of service requirement, or an energy state of an apparatus.

### Embodiment 3

The first apparatus according to embodiment 1 or 2, wherein, wherein
at least one of the at least one user equipment property comprises a random access resource used for a preceding transmission of the random access message.

### Embodiment 4

The first apparatus according to any of embodiments 1 to 3, wherein the instructions, when executed by the at least one processor, cause the apparatus further to
obtaining at least one barring indication of at least one barred random access resource from a network node.

### Embodiment 5

The first apparatus according to embodiment 4, wherein
selecting the random access resource comprises avoiding at least one or all barred random access resources indicated by the at least one barring indication for transmitting a random access message.

### Embodiment 6

The first apparatus according to any of embodiments 1 to 5, wherein
at least one of the at least one association causes the apparatus to select a random access resource used for a preceding transmission for a subsequent re-transmission of the random access message or
at least one of the at least one association causes the apparatus to select the random access resource used for a preceding transmission for a subsequent re-transmission of the random access message, when a barring indication indicating the radio access resource has been obtained by the apparatus after the preceding transmission of the random access message using the random access resource.

### Embodiment 7

A second apparatus comprising at least one processor; and at least one memory including instructions that, when executed by the at least one processor, cause the apparatus further to
constructing at least one association between at least one user equipment property and at least one random access resource, and
providing the at least one association to a user equipment.

### Embodiment 8

The second apparatus according to embodiment 7, wherein the instructions, when executed by the at least one processor, cause the apparatus further to
receiving at least one of an initial transmission or a re-transmission of a random access message from a user equipment using one of the at least one random access resource.

### Embodiment 9

The second apparatus according to embodiment 7 or 8, wherein at least one of
constructing the at least one association comprises selecting one or a subset of or all random access resources from a set of configured random access resources or
constructing the at least one association comprises configuring one or a subset or all of a set of available random access resources.

### Embodiment 10

The second apparatus according to any of embodiments 7 to 9, wherein the instructions, when executed by the at least one processor, cause the apparatus further to
providing at least one adapted association between at least one user equipment state and at least one random access resource to a user equipment.

### Embodiment 11

The second apparatus according to any of embodiments 7 to 10, wherein
at least one of the at least one user equipment property comprises at least one of an apparatus identification, a random access transmission time, a number of random access message transmissions, a quality of service requirement, or an energy state of an apparatus.

### Embodiment 12

The second apparatus according to any of embodiments 7 to 11, wherein
at least one of the at least one user equipment property comprises a random access resource used for a preceding transmission of the random access message.

### Embodiment 13

The second apparatus according to any of embodiments 7 to 12, wherein the instructions, when executed by the at least one processor, cause the apparatus further to
estimating an access latency for at least one random access resource, or
estimating an access latency for at least one random access resource and constructing at least one association based on the estimated access latency.

Embodiment 14

The second apparatus according to any of embodiments 7 to 13, wherein the instructions, when executed by the at least one processor, cause the apparatus further to
determining that at least one of the at least one random access resource is congested and
selectively barring the congested random access resource for initial transmissions of random access messages by user equipments.

### Embodiment 15

The second apparatus according to embodiment 14, wherein
selectively barring comprise transmitting at least one barring indication of at least one barred random access resource to at least one user equipment.

### Embodiment 16

A system comprising at least one apparatus according to embodiments 1 to 6 and at least one apparatus according to embodiments 7 to 15.

### Embodiment 17

A computer program, the computer program when executed by a processor causing an apparatus, e.g. the apparatus according to any of the embodiments 1 to 6, to perform and/or control the actions and/or steps performed and/or controlled by the apparatus of any of embodiments 1 to 6.

### Embodiment 18

A computer program, the computer program when executed by a processor causing an apparatus, e.g. the apparatus according to any of the embodiments 7 to 15, to perform and/or control the actions and/or steps performed and/or controlled by the apparatus of any of embodiments 7 to 15.

### Embodiment 19

A computer program product comprising a computer program according to embodiment 17 or 18.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Having the same meaning as the expression “A and/or B”, the expression “at least one of A or B” may be used herein. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are (e.g., only) exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of (e.g., only) one of the enumerated features is possible. The specific combination of all subsequently enumerated features may as well be considered. Also, a plurality of (e.g., only) one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

### List of Abbreviations

ACK Acknowledgement
BS Base station
DCI Downlink Control Information
LTE Long Term Evolution
KPI Key performance indicator
MAC Medium Access Control
NW Network
NR New Radio
PRACH Physical Random Access CHannel
RA Random Access
RAN Radio Access Network
RAR Random Access Response
RNTI Radio Network Temporary Identity
RO RACH Occasion
RRC Radio Resource Control
UE User Equipment
DL Downlink
UL Uplink
gNB 5G Node B, base station
NR New Radio
PDB Packet delay budget
PDCCH Physical downlink control channel
PDSCH Physical downlink shared channel
QoS Quality of service
RRC Radio Resource Control

1-17. (canceled)

18. An apparatus, comprising:
at least one processor; and
at least one memory including instructions that, when executed by the at least one processor, cause the apparatus at least to perform:
obtaining at least one association between at least one user equipment property and at least one random access resource from a network node,
selecting a random access resource from the at least one random access resource based on both at least one of the at least one association and a user equipment property of the apparatus, and
at least one of transmitting initially or re-transmitting a random access message to a network node using the selected random access resource.

19. The apparatus according to claim 18, wherein at least one of the at least one user equipment property comprises at least one of:
an apparatus identification,
a random access transmission time,
a number of random access message transmissions,
a quality of service requirement, or
an energy state of an apparatus.

20. The apparatus according to claim 18, wherein at least one of the at least one user equipment property comprises a random access resource used for a preceding transmission of the random access message.

21. The apparatus according to claim 18, further caused to perform:
obtaining at least one barring indication of at least one barred random access resource from a network node.

22. The apparatus according to claim 21, wherein selecting the random access resource comprises avoiding at least one or all barred random access resources indicated by the at least one barring indication for transmitting a random access message.

23. The apparatus according to claim 18, wherein
at least one of the at least one association causes the apparatus to select a random access resource used for a preceding transmission for a subsequent re-transmission of the random access message, or
at least one of the at least one association causes the apparatus to select a random access resource used for a preceding transmission for a subsequent re-transmission of the random access message, when a barring indication indicating the radio access resource has been obtained by the apparatus after the preceding transmission of the random access message using the random access resource.

24. The apparatus according to claim 18, wherein at least one association causes the selection of a certain special random access resource or overflow random access resource to be used by the apparatus when the apparatus has failed to access the network at least a predetermined number of times.

25. An apparatus, comprising:
at least one processor; and
at least one memory including instructions that, when executed by the at least one processor, cause the apparatus at least to perform:
constructing at least one association between at least one user equipment property and at least one random access resource, and
providing the at least one association to a user equipment.

26. The apparatus according to claim 25, further caused to perform:
receiving at least one of an initial transmission or a re-transmission of a random access message from a user equipment using one of the at least one random access resource.

27. The apparatus according to claim 25, wherein at least one of:
the constructing the at least one association comprises selecting one or a subset of or all random access resources from a set of configured random access resources, or
the constructing the at least one association comprises configuring one or a subset or all of a set of available random access resources.

28. The apparatus according to claim 25, further caused to perform:
providing at least one adapted association between at least one user equipment state and at least one random access resource to a user equipment.

29. The apparatus according to claim 25, wherein at least one of the at least one user equipment property comprises at least one of:
an apparatus identification,
a random access transmission time,
a number of random access message transmissions,
a quality of service requirement, or
an energy state of an apparatus.

30. The apparatus according to claim 25, wherein at least one of the at least one user equipment property comprises a random access resource used for a preceding transmission of the random access message.

31. The apparatus according to claim 25, further caused to perform:
estimating an access latency for at least one random access resource, or
estimating an access latency for at least one random access resource and constructing at least one association based on the estimated access latency.

32. The apparatus according to claim 25, further caused to perform:
determining that at least one of the at least one random access resource is congested, and
selectively barring the congested random access resource for initial transmissions of random access messages by user equipments.

33. The apparatus according to claim 32, wherein the selectively barring comprises transmitting at least one barring indication of at least one barred random access resource to at least one user equipment.
